(19) United States
(12) Patent Application Publication
(10) Pub. No.: US 2018/0005478 A1
(43) Pub. Date: Jan. 4, 2018

(54) BANKNOTE CLASSIFICATION AND IDENTIFICATION METHOD AND DEVICE BASED ON LAB COLOR SPACE

(71) Applicant: GRG BANKING EQUIPMENT CO., LTD., Guangzhou, Guangdong (CN)

(72) Inventors: Jian CHEN, Guangzhou, Guangdong (CN); Shanling CUI, Guangzhou, Guangdong (CN); Qianwen WANG, Guangzhou, Guangdong (CN); Jing XU, Guangzhou, Guangdong (CN)

(73) Assignee: GRG BANKING EQUIPMENT CO., LTD., Guangzhou, Guangdong (CN)

(21) Appl. No.: 15/541,705

(22) PCT Filed: Jun. 29, 2015
(86) PCT No.: PCT/CN2015/082615

§ 371 Date: Jul. 5, 2017

(30) Foreign Application Priority Data
Jan. 22, 2015 (CN) 201510033336.2

(51) Int. Cl. G07D 7/202; G06T 7/90

(52) U.S. Cl. CPC G07D 7/205; G06T 7/90

(57) ABSTRACT

A method and a device for banknote classification and recognition based on a Lab color space are provided for improving the denomination recognition rate. The method includes obtaining an RGB image of a banknote to be detected; calculating gray values Gray R, Gray G and Gray B of the RGB image in red (R), green (G) and blue (B) wavebands; converting the gray values Gray R, Gray G and Gray B into gray values Gray a and Gray b in the Lab color space; and substituting a product of Gray a and Gray b and a difference between the absolute value of Gray a and the absolute value of Gray b into preset formulas to determine a category of the banknote to be detected.

The present application claims the priority to Chinese Patent Application No. 201510033336.2, titled “BANKNOTE CLASSIFICATION AND RECOGNITION METHOD AND DEVICE BASED ON LAB COLOR SPACE”, filed on Jan. 22, 2015 with the State Intellectual Property Office of the People's Republic of China, which is incorporated herein by reference in its entirety.

### TECHNICAL FIELD

The present disclosure relates to the field of classification and recognition of a banknote denomination, and in particular to a banknote classification and recognition method and device based on a Lab color space.

### BACKGROUND

With the continuous prosperity of the domestic market economy, the amount of banknotes in circulation is becoming larger and larger. Financial institutions require that financial equipment must support recognition of different denominations of Renminbi. A Lab color space is a color space close to human vision. “L” (Luminosity) represents brightness, and each of “a” and “b” represents a dimension between two opposite colors. “L” ranges from 0 to 100, which represents black to pure white, “a” represents a color between red and green, which ranges from +127 to −128, and “b” represents a color between blue and yellow, which ranges from +127 to −128, where a positive value represents a warm color, and a negative values represents a cool color. The Lab color space has a wide color gamut, not only including the whole color gamut of RGB and CMYK, but also can express colors which cannot be expressed by RGB and CMYK. All the colors which can be perceived by human eyes can be expressed through a Lab model. In addition, the Lab color model can also overcome the disadvantage of uneven color distribution of a RGB color model because of too many transitional colors between blue and green and a lack of yellow and other colors between green and red in the RGB model.

At present, the core technology of financial equipment is based on real-time banknote image processing and image recognition. One of common methods is to recognize using geometrical features (length and width) of images of banknotes of different denominations.

However, since images of banknotes are obtained through a high-speed collection device, distortion and deformation are inevitable, which leads to instability of the geometric features, and results in a decrease in the recognition rate. Another method is to recognize denominations using a gray difference of different regions in a single channel gray image. However, the difference of gray features of some different denominations is not significant, and a main feature region for recognition may be stained. Therefore, there is a risk of misrecognizing banknotes of different denominations or different currency types.

The conventional technology has a drawback that a conventional recognition device can only obtain a single channel grayscale image, which cannot effectively recognize the color of a banknote, resulting in a low denomination recognition rate.

### SUMMARY

A banknote classification and recognition method and device based on a Lab color space are provided according to embodiments of the present disclosure, to improve the denomination recognition rate.

A banknote classification and recognition method based on a Lab color space is provided according to the embodiments of the present disclosure. The technical solutions include:

obtaining an RGB image of a banknote to be detected;

calculating gray values Gray R, Gray G and Gray B of the RGB image in red (R), green (G) and blue (B) wavebands;

converting the gray values Gray R, Gray G and Gray B into gray values Gray a and Gray b in the Lab color space; and

substituting a product of Gray a and Gray b and a difference between the absolute value of Gray a and the absolute value of Gray b into preset formulas to determine a category of the banknote to be detected.

Preferably, the substituting the product of Gray a and Gray b and the difference between the absolute value of Gray a and the absolute value of Gray b into the preset formulas to obtain the category of the banknote to be detected includes:

determining the banknote to be detected as 100 Yuan, in a case that the product of Gray a and Gray b is greater than zero, and the difference between the absolute value of Gray a and the absolute value of Gray b is greater than 20;

determining the banknote to be detected as 20 Yuan, in a case that the product of Gray a and Gray b is greater than zero, and the difference between the absolute value of Gray a and the absolute value of Gray b is less than 5;

determining the banknote to be detected as 50 Yuan, in a case that the product of Gray a and Gray b is less than zero, and the difference between the absolute value of Gray a and the absolute value of Gray b is greater than 10; and

determining the banknote to be detected as 10 Yuan, in a case that Gray a is less than zero, and the difference between the absolute value of Gray a and the absolute value of Gray b is less than 10.

Preferably, the obtaining the RGB image of the banknote to be detected includes: extracting a complete region of the banknote to be detected; and obtaining the RGB image of the complete region via a multi-spectral recognition device.

Preferably, the calculating the gray values Gray R, Gray G and Gray B of the RGB image in the red (R), green (G) and blue (B) wavebands includes: selecting a region of a head portrait of Mao Zedong in the RGB image as a target region; and calculating the gray values Gray R, Gray G and Gray B in the red (R), green (G) and blue (B) wavebands based on the target region.

Preferably, the converting Gray R, Gray G and Gray B into the gray values Gray a and Gray b in the Lab color space includes:

substituting Gray R, Gray G and Gray B into conversion formulas to obtain Gray a and Gray b, where the conversion formulas are:

Gray a=1.4749*(0.2213*Gray R−0.3390*Gray G+0.1177*Gray B)+128, and

Gray b=0.6245*(0.1949*Gray R+0.6057*Gray G−0.8006*Gray B)+128.

A banknote classification and recognition device based on a Lab color space is provided according to the embodiments of the present disclosure. The technical solutions include:

an obtaining module, configured to obtain an RGB image of a banknote to be detected;

a processing module, configured to calculate gray values Gray R, Gray G and Gray B of the RGB image obtained by the obtaining module in red (R), green (G) and blue (B) wavebands;

a converting module, configured to convert Gray R, Gray G and Gray B calculated by the processing module into gray values Gray a and Gray b in the Lab color space; and

a determining module, configured to substitute a product of Gray a and Gray b and a difference between the absolute value of Gray a and the absolute value of Gray b into preset formulas to determine a category of the banknote to be detected.

Preferably, the determining module is configured to:

determine the banknote to be detected as 100 Yuan, in a case that the product of Gray a and Gray b is greater than zero, and the difference between the absolute value of Gray a and the absolute value of Gray b is greater than 20;

determine the banknote to be detected as 20 Yuan, in a case that the product of Gray a and Gray b is greater than zero, and the difference between the absolute value of Gray a and the absolute value of Gray b is less than 5;

determine the banknote to be detected as 50 Yuan, in a case that the product of Gray a and Gray b is less than zero, and the difference between the absolute value of Gray a and the absolute value of Gray b is greater than 10; and

determine the banknote to be detected as 10 Yuan, in a case that Gray a is less than zero, and the difference between the absolute value of Gray a and the absolute value of Gray b is less than 10.

Preferably, the obtaining module is configured to obtain the RGB image of a complete region of the banknote to be detected via a multi-spectral recognition device.

Preferably, the processing module is configured to extract a region of a head portrait of Mao Zedong in the RGB image as a target region; and calculate the gray values Gray R, Gray G and Gray B in the red (R), green (G) and blue (B) wavebands based on the target region.

Preferably, the converting module is configured to convert the gray values Gray R, Gray G and Gray B into the gray values Gray a and Gray b in the Lab color space according to conversion formulas of

Gray a=1.4749*(0.2213*Gray R−0.3390*Gray G+0.1177*Gray B)+128, and

Gray b=0.6245*(0.1949*Gray R+0.6057*Gray G−0.8006*Gray B)+128.

The embodiments of the present disclosure have the following beneficial effects. On the basis that the difference among colors of banknotes to be detected of different denominations is large, the RGB image of a banknote to be detected is obtained. Gray values Gray R, Gray G and Gray B of the RGB image in red (R), green (G) and blue (B) wavebands are calculated, and Gray R, Gray G and Gray B are converted into gray values Gray a and Gray b in the Lab color space. The product of Gray a and Gray b and the difference between the absolute value of Gray a and the absolute value of Gray b are substituted into preset formulas to effectively recognize different denominations of banknotes, improving the denomination recognition rate.

### BRIEF DESCRIPTION OF THE DRAWINGS

To illustrate technical solutions according to embodiments of the present disclosure or in the conventional technologies more clearly, drawings to be used in the descriptions of the conventional technologies or the embodiments are described briefly hereinafter. Apparently, the drawings described hereinafter are only for some embodiments of the present disclosure, and other drawings may be obtained by those skilled in the art based on those drawings without creative efforts.

FIG. 1 is a schematic flow chart of a banknote classification and recognition method based on a Lab color space according to an embodiment of the present disclosure;

FIG. 2 is a schematic flow chart of a banknote classification and recognition method based on a Lab color space according to another embodiment of the present disclosure; and

FIG. 3 is a schematic structural diagram of a banknote classification and recognition device based on a Lab color space according to an embodiment of the present disclosure.

### DETAILED DESCRIPTION OF THE EMBODIMENTS

A banknote classification and recognition method and device based on a Lab color space are provided according to embodiments of the present disclosure, to improve the denomination recognition rate.

Technical solutions of the embodiments of the present disclosure are illustrated clearly and completely in conjunction with the drawings of the embodiments of the present disclosure. Apparently, the described embodiments are merely a few rather than all of the embodiments of the present disclosure. All other embodiments obtained by those skilled in the art based on the embodiments of the present disclosure without creative efforts shall fall within the protection scope of the present disclosure.

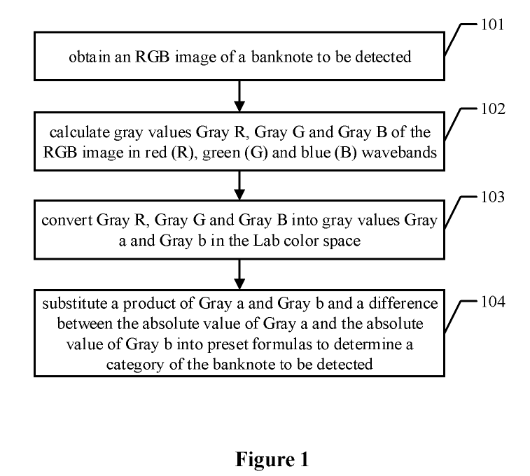

Reference is made to FIG. 1. A banknote classification and recognition method based on a Lab color space is provided according to an embodiment of the present disclosure. The method includes steps 101 to 104.

In step 101, an RGB image of a banknote to be detected is obtained.

In the embodiment, the RGB image of the banknote to be detected is obtained.

In step 102, gray values Gray R, Gray G and Gray B of the RGB image in red (R), green (G) and blue (B) wavebands are calculated.

In the embodiment, the gray values Gray R, Gray G and Gray B of the obtained RGB image in red (R), green (G) and blue (B) wavebands are calculated.

In step 103, Gray R, Gray G and Gray B are converted into gray values Gray a and Gray b in the Lab color space.

In the embodiment, Gray R, Gray G and Gray B are converted into the gray values Gray a and Gray b in the Lab color space according to formulas. The Lab color space is composed of a luminosity component L and two chrominance components. The two chrominance components are respectively component “a” ranging from green to red and component “b” ranging from blue to yellow.

In step 104, a product of Gray a and Gray b and a difference between the absolute value of Gray a and the absolute value of Gray b are substituted into preset formulas to determine a category of the banknote to be detected.

In the embodiment, the product of Gray a and Gray b and the difference between the absolute value of Gray a and the absolute value of Gray b are substituted into the preset formula to obtain the category of the banknote to be detected.

In the embodiment, on the basis that the difference among colors of banknotes of different denominations is large, the RGB image of a banknote to be detected is obtained. Gray values Gray R, Gray G and Gray B of the RGB image in red (R), green (G) and blue (B) wavebands are calculated, and Gray R, Gray G and Gray B are converted into gray values Gray a and Gray b in the Lab color space. The product of Gray a and Gray b and the difference between the absolute value of Gray a and the absolute value of Gray b are substituted into preset formulas to effectively recognize different denominations of banknotes, thereby improving the denomination recognition rate.

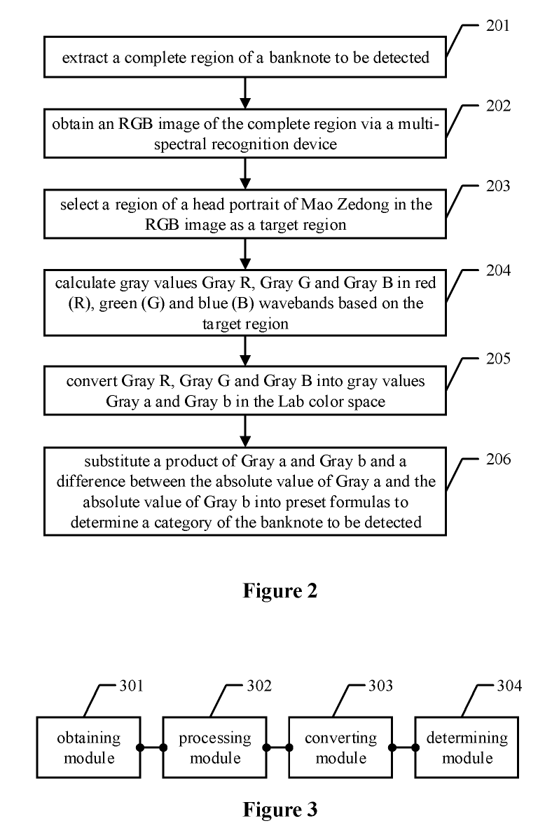

Reference is made to FIG. 2. A banknote classification and recognition method based on a Lab color space is provided according to another embodiment of the present disclosure. The method includes steps 201 to 205.

In step 201, a complete region of a banknote to be detected is extracted.

In the embodiment, the complete banknote region may be recognized and obtained by using an edge detection algorithm.

In step 202, an RGB image of the complete region is obtained via a multi-spectral recognition device.

In the embodiment, an image of the complete region of the banknote to be detected in the RGB spectrums is obtained via the multi-spectral recognition device.

In step 203, a region of a head portrait of Mao Zedong in the RGB image is selected as a target region.

In the embodiment, recognition is performed mainly on banknotes of four denominations in the fifth series of Renminbi, namely banknotes of 10 Yuan, 20 Yuan, 50 Yuan, and 100 Yuan. As an image feature perceived by human eyes, a banknote of 100 Yuan Renminbi appears in red, a banknote of 50 Yuan Renminbi appears in green, a banknote of 20 Yuan Renminbi appears in nearly yellow, and a pattern feature of 10 Yuan Renminbi appears in nearly blue. The region of the head portrait of Mao Zedong, in which banknote color information is the most abundant, is determined as the target region.

In step 204, gray values Gray R, Gray G and Gray B in red (R), green (G) and blue (B) wavebands are calculated based on the target region.

In the embodiment, the gray values Gray R, Gray G and Gray B in the red (R), green (G) and blue (B) wavebands are calculated based on the determined target region.

In step 205, Gray R, Gray G and Gray B are converted into gray values Gray a and Gray b in the Lab color space.

In the embodiment, Gray R, Gray G and Gray B are converted into the gray values Gray a and Gray b in the Lab color space according to conversion formulas:

Gray a=1.4749*(0.2213*Gray R−0.3390*Gray G+0.1177*Gray B)+128; and

Gray b=0.6245*(0.1949*Gray R+0.6057*Gray G−0.8006*Gray B)+128.

It should be noted that, based on a model of the Lab color space, it is appropriate to use a positive part of the coordinate axis a to describe a color feature of a banknote of 100 Yuan, a negative part of the coordinate axis a to describe a color feature of a banknote of 50 Yuan, a positive part of the coordinate axis b to describe a color feature of a banknote of 20 Yuan, and a negative part of the coordinate axis b to describe a color feature of a banknote of 10 Yuan. In addition, the method for describing features further includes a relation between component a and component b of the same denomination.

In step 206, a product of Gray a and Gray b, and a difference between the absolute value of Gray a and the absolute value of Gray b are substituted into preset formulas to determine a category of the banknote to be detected.

In the embodiment, assuming that X=|Gray a|=|Gray b|, E=Gray a, and F=Gray b, the preset formulas are respectively as follows.

In preset formula 1, if E*F>0, and X−Y>20, the banknote is determined as a banknote of 100 Yuan Renminbi.

In preset formula 2, if E*F<0, and X−Y>10, the banknote is determined as a banknote of 50 Yuan Renminbi;

In preset formula 3, if E*F>0, and X−Y<5, the banknote is determined as a banknote of 20 Yuan Renminbi; and

In preset formula 4, if E<0, and X−Y<10, the banknote is determined as a banknote of 10 Yuan Renminbi.

In the present embodiment, after the converting with the formulas, feature values of the Renminbi banknotes of different denominations in the Lab space may be as follows:

| denomination | Gray L | Gray a | Gray b |
|---|---|---|---|
| 100 Yuan | 89 | 35 | 7 |
| 50 Yuan | 84 | −26 | 7 |
| 20 Yuan | 77 | 3 | 10 |
| 10 Yuan | 87 | −6 | 0 |

Since the difference among luminosity components Gray L of different denominations is not large, the luminosity components Gray L are not used as a reference for determination. It follows from the above table that, for a banknote of 100 Yuan, the value of Gray a is positive and a larger value of the absolute value (|Gray a|>|Gray b|) indicates a more red color; and for a banknote of 50 Yuan, the value of Gray a is negative and a larger value of the absolute value (|Gray a|>|Gray b|) indicates a more green color. Therefore, a relation among X=|Gray a|, Y=|Gray b|, E=Gray a, and F=Gray b can be used as the determination basis.

In the embodiment, on the basis that the difference among colors of banknotes of different denominations is large, the RGB image of a banknote to be detected is first obtained. Gray values Gray R, Gray G and Gray B of the RGB image in red (R), green (G) and blue (B) wavebands are calculated, and Gray R, Gray G and Gray B are converted into gray values Gray a and Gray b in the Lab color space. The product of Gray a and Gray b and the difference between the absolute value of Gray a and the absolute value of Gray b are substituted into preset formulas to effectively identify the banknotes of different denominations, thereby improving the denomination recognition rate. In addition, |Gray a|, |Gray b|, Gray a, and Gray b are selected as the determination basis, which improves the operational flexibility.

Reference is made to FIG. 3. A banknote classification and recognition device based on a Lab color space is provided according to the present disclosure. The device includes an obtaining module 301, a processing module 302, a converting module 303 and a determining module 304.

The obtaining module 301 is configured to obtain an RGB image of a banknote to be detected.

The processing module 302 is configured to calculate gray values Gray R, Gray G and Gray B of the RGB image obtained by the obtaining module in red (R), green (G) and blue (B) wavebands.

The converting module 303 is configured to convert Gray R, Gray G and Gray B calculated by the processing module 302 into gray values Gray a and Gray b in the Lab color space.

The determining module 304 is configured to substitute a product of Gray a and Gray b and the difference between the absolute value of Gray a and the absolute value of Gray b into preset formulas to determine a category of the banknote to be detected.

The determining module 304 may be further configured to:

determine the banknote to be detected as 100 Yuan, in a case that the product of Gray a and Gray b is greater than zero, and the difference between the absolute value of Gray a and the absolute value of Gray b is greater than 20;

determine the banknote to be detected as 20 Yuan, in a case that the product of Gray a and Gray b is greater than zero, and the difference between the absolute value of Gray a and the absolute value of Gray b is less than 5;

determine the banknote to be detected as 50 Yuan, in a case that the product of Gray a and Gray b is less than zero, and the difference between the absolute value of Gray a and the absolute value of Gray b is greater than 10; and

determine the banknote to be detected as 10 Yuan, in a case that Gray a is less than zero, and the difference between the absolute value of Gray a and the absolute value of Gray b is less than 10.

Further, the obtaining module 301 may be configured to obtain the RGB image of a complete region of the banknote to be detected via a multi-spectral recognition device.

Further, the processing module 302 may be configured to extract a region of a head portrait of Mao Zedong in the RGB image as a target region, and calculate the gray values Gray R, Gray G and Gray B based on the target region.

Further, the converting module 303 may be configured to convert Gray R, Gray G and Gray B into the gray values Gray a and Gray b in the Lab color space according to conversion formulas of:

Gray a=1.4749*(0.2213*Gray R−0.3390*Gray G+0.1177*Gray B)+128, and

Gray b=0.6245*(0.1949*Gray R+0.6057*Gray G−0.8006*Gray B)+128.

In summary, the above embodiments are only intended to illustrate the technical solutions of the present disclosure, but not to limit the present disclosure. Though the present disclosure has been described in detail with the above embodiments, it should be understood by those skilled in the art that, the technical solutions described in the above embodiments can still be modified or some of technical features can be equivalently substituted, and those modifications and substitutions do not depart from the spirit and the scope of the technical solutions of all the embodiments of the present disclosure.

1. A banknote classification and recognition method based on a Lab color space, comprising:
obtaining an RGB image of a banknote to be detected;
calculating gray values Gray R, Gray G and Gray B of the RGB image in red (R), green (G) and blue (B) wavebands;
converting the gray values Gray R, Gray G and Gray B into gray values Gray a and Gray b in the Lab color space; and
substituting a product of Gray a and Gray b and a difference between the absolute value of Gray a and the absolute value of Gray b into preset formulas to determine a category of the banknote to be detected.

2. The method according to claim 1, wherein the substituting the product of Gray a and Gray b and the difference between the absolute value of Gray a and the absolute value of Gray b into the preset formula to obtain the category of the banknote to be detected comprises:
determining the banknote to be detected as 100 Yuan, in a case that the product of Gray a and Gray b is greater than zero, and the difference between the absolute value of Gray a and the absolute value of Gray b is greater than 20;
determining the banknote to be detected as 20 Yuan, in a case that the product of Gray a and Gray b is greater than zero, and the difference between the absolute value of Gray a and the absolute value of Gray b is less than 5;
determining the banknote to be detected as 50 Yuan, in a case that the product of Gray a and Gray b is less than zero, and the difference between the absolute value of Gray a and the absolute value of Gray b is greater than 10; and
determining the banknote to be detected as 10 Yuan, in a case that Gray a is less than zero, and the difference between the absolute value of Gray a and the absolute value of Gray b is less than 10.

3. The method according to claim 1, wherein the obtaining the RGB image of the banknote to be detected comprises:
extracting a complete region of the banknote to be detected; and
obtaining the RGB image of the complete region via a multi-spectral recognition device.

4. The method according to claim 3, wherein the calculating the gray values Gray R, Gray G and Gray B of the RGB image in the red (R), green (G) and blue (B) wavebands comprises:
selecting a region of a head portrait of Mao Zedong in the RGB image as a target region; and
calculating the gray values Gray R, Gray G and Gray B in the red (R), green (G) and blue (B) wavebands based on the target region.

5. The method according to claim 1, wherein the converting Gray R, Gray G and Gray B into the gray values Gray a and Gray b in the Lab color space comprises:
substituting Gray R, Gray G and Gray B into conversion formulas to obtain Gray a and Gray b, wherein the conversion formulas are:
Gray a=1.4749*(0.2213*Gray R−0.3390*Gray G+0.1177*Gray B)+128, and
Gray b=0.6245*(0.1949*Gray R+0.6057*Gray G−0.8006*Gray B)+128.

6. A banknote classification and recognition device based on a Lab color space, comprising:
an obtaining module, configured to obtain an RGB image of a banknote to be detected;
a processing module, configured to calculate gray values Gray R, Gray G and Gray B of the RGB image obtained by the obtaining module in red (R), green (G) and blue (B) wavebands;
a converting module, configured to convert Gray R, Gray G and Gray B calculated by the processing module into gray values Gray a and Gray b in the Lab color space; and
a determining module, configured to substitute a product of Gray a and Gray b and a difference between the absolute value of Gray a and the absolute value of Gray b into preset formulas to determine a category of the banknote to be detected.

7. The device according to claim 6, wherein the determining module is configured to:
determine the banknote to be detected as 100 Yuan, in a case that the product of Gray a and Gray b is greater than zero, and the difference between the absolute value of Gray a and the absolute value of Gray b is greater than 20;
determine the banknote to be detected as 20 Yuan, in a case that the product of Gray a and Gray b is greater than zero, and the difference between the absolute value of Gray a and the absolute value of Gray b is less than 5;
determine the banknote to be detected as 50 Yuan, in a case that the product of Gray a and Gray b is less than zero, and the difference between the absolute value of Gray a and the absolute value of Gray b is greater than 10; and
determine the banknote to be detected as 10 Yuan, in a case that Gray a is less than zero, and the difference between the absolute value of Gray a and the absolute value of Gray b is less than 10.

8. The device according to claim 6, wherein the obtaining module is configured to obtain the RGB image of a complete region of the banknote to be detected via a multi-spectral recognition device.

9. The device according to claim 8, wherein the processing module is configured to
extract a region of a head portrait of Mao Zedong in the RGB image as a target region; and
calculate the gray values Gray R, Gray G and Gray B of in the red (R), green (G) and blue (B) wavebands based on the target region.

10. The device according to claim 6, wherein the converting module is configured to convert the gray values Gray R, Gray G and Gray B into the gray values Gray a and Gray b in the Lab color space according to conversion formulas of
Gray a=1.4749*(0.2213*Gray R−0.3390*Gray G+0.1177*Gray B)+128, and
Gray b=0.6245*(0.1949*Gray R+0.6057*Gray G−0.8006*Gray B)+128.
